(19) United States
(12) Patent Application Publication
(10) Pub. No.: US 2020/0221740 A1
(43) Pub. Date: Jul. 16, 2020

(54) TERMINALIA FERDINANDIANA LEAF EXTRACT AND PRODUCTS CONTAINING EXTRACT OF TERMINALIA FERDINANDIANA LEAF

(71) Applicant: RISING PHOENIX INDUSTRIES PTY LTD, MOUNT LAWLEY (AU)

(72) Inventors: Ian Edwin Cock, Logan Central (AU); David John Boehme, Humpty Doo (AU); Roslyn Anne Miles, Myaree (AU)

(21) Appl. No.: 16/484,014

(22) PCT Filed: Feb. 8, 2018
(86) PCT No.: PCT/AU2018/050096

§ 371 Date: Aug. 6, 2019

(30) Foreign Application Priority Data
Feb. 8, 2017 (AU) 2017900391

(51) Int. Cl. A23L 3/3472; A01N 65/08; A23L 3/3544

(52) U.S. Cl. CPC A23L 3/3472; A23V 2002/00; A23L 3/3544; A01N 65/08

(57) ABSTRACT

An extract or composition containing an extract derived from Terminalia ferdinandiana (T. ferdinandiana) leaf as an antimicrobial agent to preserve or prolong storage or shelf-life of perishable animal and/or plant based products. Optionally, the extract can include T. ferdinandiana fruit extract. The leaf extract can be a methanolic, aqueous, ethyl acetate, alcohol, chloroform or hexane extract. The composition can be an antimicrobial agent for perishable animal and/or plant based products, such as food for humans or animals. Also, a method of inhibiting or controlling growth of bacteria on a food preparation surface, on a food preparation tool or utensil, on food packaging or on an internal or external surface of a food product, the method including applying bacteria includes applying a composition containing an extract of Terminalia ferdinandiana (T. ferdinandiana ) leaf, such as by dipping or drenching.

### TECHNICAL FIELD

The present invention relates to natural extracts/derivatives of Terminalia ferdinandiana (T. ferdinandiana ).

### BACKGROUND TO THE INVENTION

Hereinafter, Terminalia ferdinandiana may be referred to as T. ferdinandiana for ease of reference.

T. ferdinandiana is a small, deciduous tree which grows wild extensively throughout the subtropical woodlands of northern tracts of Australia, typically in the Northern Territory and Western Australia.

T. ferdinandiana bears an abundant crop of small plum-like fruits. The fruit is known to have very high vitamin C content, and is a source of antioxidants, folic acid and iron. The fruit and extracts of the fruit are used in foods, dietary supplements and pharmaceuticals.

The commonest use of T. ferdinandiana fruits is for gourmet jams, sauces, juices, ice-cream, cosmetics, flavours and pharmaceuticals.

Examples of cosmetic vehicles for the T. ferdinandiana fruit extract have been proposed in European patent document EP 1581513. Another patent document U.S. Pat. No. 7,175,862 discloses a method of producing a powder containing ascorbic acid (vitamin C), antioxidants and phytochemicals from the fruit of the T. ferdinandiana plant. U.S. Pat. No. 7,175,862 mentions use of the powdered T. ferdinandiana fruit for the reduction of free radicals in the human body.

T. ferdinandiana fruit is also known for having antimicrobial properties. As a native fruit of northern Australia, the fruit has a long history of use by indigenous Australians as a food and a medicinal agent. The fruit was eaten during long hunting trips by indigenous Australians, more so for its medicinal properties than as a food. The medicinal properties of T. ferdinandiana have not been well understood or fully evaluated.

A study by I. E. Cock and S. Mohanty reporting on an evaluation of the antimicrobial properties of T. Ferdinandiana fruit pulp was published in the Pharmacgnosy Journal 2011 [vol 3 | issue 20]. That study focussed on the bacterial growth inhibitory potential of T. ferdinandiana fruit pulp and recognised that further studies were needed to examine other medicinally important bioactivities of T. ferdinandiana fruit.

Chilled cooked and fresh seafood are widely recognised as being particularly vulnerable to having a relatively short shelf life leading to spoilage.

Retaining presentation and palatability characteristics are great challenges for the farmed and wild caught seafood industries in order to reduce spoilage and wasted food product. Remote product source locations and long distribution/delivery chains exacerbate these issues. Extension of storage life and shelf-life through ‘on-farm’ processing and packaging protocols would greatly benefit the seafood industry.

Shelf life and storage timeframes, and associated spoilage issues, are not limited to the seafood industry. Fresh fruits and vegetables, as well as red and white meat products, all have a limited storage and shelf life and an associated percentage of spoilage throughout their respective industries.

Chilling, cook chill and use of clever packaging techniques, such as use of inert gases in packaging and use of absorbent pads to absorb fluids, can extend product storage and shelf life. However, there are limitations to such techniques, and a wider arsenal of techniques and shelf-life/storage mechanisms would be very valuable to all of these food producing industries and would benefit of consumers.

Food deterioration through spoilage results in large amounts of wasted food as well as a possibility of food borne illnesses. Spoilage may result in a deterioration of flavour, visual appearance, texture or nutritional value of the food. Even food that is still edible but unpalatable or unappealing to the eye of the consumer is likely to be unsellable and wasted. Spoiled food also increases risk of disease and food poisoning.

One of the major causes of food spoilage is oxidative rancidity. This occurs when the polyunsaturated and monounsaturated components of foods react with oxygen to form peroxides, which subsequently decompose to form ketones, aldehydes and other volatile compounds. Limiting this oxidisation would greatly benefit the longevity of fresh and processed food products.

The incorporation of high antioxidant fruits, herbs and spices into fresh and processed foods to retard rancidity and improve shelf life and safety is now a recognised method of lessening oxidative rancidity and prolonging food shelf life. However, microbial spoilage may often still continue in the presence of high antioxidant contents.

Microbial spoilage is a major contributing factor to food deterioration, particularly in perishable foods, accounting for an estimated 25% of all food wastage. Spoilage of this type can be induced through either the introduction of microbes as a result of improper handling/storage techniques, or through the proliferation of pre-existing microbes when conditions are favourable for growth.

Furthermore, some common food spoilage microbes may also cause serious food poisoning. This is a particular area of concern and there is much effort to develop improved preservation strategies. Methods aimed at inhibiting microbial growth must effectively control initial populations, regrowth of post-processing microbial survivors and contaminant induced populations. This may be achieved by a number of methodologies including alteration of temperature (heating, chilling), pH (fermentation end products), water activity (dehydration) or oxygen availability (canning, shrink wrap, reduced oxygen packaging, high pressures), irradiation or by chemical preservation.

Throughout the food processing, from initial harvesting through to product processing and packaging, the food products are exposed to a variety of abiotic elements (temperature, heat, oxygen) and biotic elements (yeasts, fungi, insects, bacteria).

The main methods of preserving perishable foodstuffs such as meat, seafood including fish and shellfish, fruit and vegetables, for a period of time is by storage at low temperatures (e.g. chilling with ice or freezing), cooking or drying (dehydrating).

Whilst these can be effective methods of controlling the growth of many food spoilage bacteria, chilling and cook-chill processing are inefficient at inhibiting the growth of psychrophilic and psychrotrophic bacteria, such as the Shewanella spp., and other preservation methods are required.

Decreasing the water activity by drying the perishable food product and/or by adding salt, or alteration of the pH of the flesh/muscle by fermenting or directly adding acids (e.g. acetic, citric, lactic) are effective at inhibiting bacterial growth in stored meats.

However, these methods also have profound effects on the taste and textural characteristics of the food product. Furthermore, health concerns associated with excess sodium consumption has resulted in a decreased use of salt as a preservative in recent years.

Other methods of delaying spoilage of perishable edible produce entail the addition of chemical preservatives. Commonly used chemical food preservatives include butylhydroxyanisol (BHA), butylated hydroxytoluene (BHT), nitrates, nitrites, sulfur dioxide (SO2) and sulfites (SO3).

Of concern, the safety of many of the chemical preservatives used in food has yet to be determined and in some cases these preservatives have been linked with serious health problems.

Chemical preservatives may cause respiratory problems, aggravate attention deficit hyperactivity disorder (ADHD) and cause anaphylactic shock in susceptible individuals. Due to greater consumer awareness and the negative perceptions of artificial preservatives, consumers are increasingly avoiding foods containing preservatives of chemical origin. Natural antimicrobial alternatives are increasingly being sought to increase the shelf life and safety of processed foods.

It has been realised that it would therefore be beneficial to control growth of microbes of initial populations in the raw product, as well as controlling regrowth of post-processing microbial survivors and contaminant induced populations.

It is with the at least one of the above limitations in mind that the present invention has been developed.

It is desirable of the present invention to provide at least one alternative or additional product and/or process that ameliorates at least one shortcoming of known products and/or processes for preserving storage and/or shelf-life of perishable product.

### SUMMARY OF THE INVENTION

With the aforementioned in mind, an aspect of the present invention provides a composition containing an extract derived from Terminalia ferdinandiana (T. ferdinandiana) leaf as an antimicrobial agent to preserve or prolong storage or shelf-life of perishable animal and/or plant based products.

Preferably the perishable animal and/or plant based products include fresh, cooked or semi-cooked, such as part cook then chill, animal and/or plant products.

In this specification, plant products are to be understood and read to include fungi products, such as mushrooms and mushroom based perishable food products.

The animal products and/or plant products may include food products for consumption by one or more of humans, pets, farmed animals or livestock.

The animal products may include marine animal based product(s), such as seafood (e.g. cooked, chilled cooked or raw crustaceans, prawn, shrimp, crab, lobster, fish, muscles, oysters, octopus, cuttlefish, squid, shellfish etc.)

The composition may also include extract of T. ferdinandiana fruit additional to the extract of T. ferdinandiana leaf.

Preferably the T. ferdinandiana leaf extract includes one or more of a methanolic extract, aqueous extract; ethyl acetate extract; alcohol extract, chloroform extract; or hexane extract, of the leaf.

Preferably the T. ferdinandiana leaf extract includes a proportion of at least one tannin. More preferably the at least one tannin includes one or more of chebulic acid, corilagen, chebulinic acid and chebulagic acid.

The T. ferdinandiana leaf extract may preferably include at least one flavone or flavonoid, such as luteolin.

A further aspect of the present invention provides a method of inhibiting growth of controlling bacteria on a food preparation surface, on a food preparation tool or utensil, on food packaging or on an internal or external surface of a food product, the method including applying bacteria includes applying a composition containing an extract of Terminalia ferdinandiana (T. ferdinandiana) leaf to the respective food preparation surface, the food preparation tool or utensil, the food packaging or to the internal or external surface of the food product.

Preferably, the step of the applying the composition includes one or more of spraying the composition onto the respective surface or putting the respective surface into a solution containing the composition.

The lactic acid may be provided as a free radical scavenging agent and/or as an anti-oxidant.

A further aspect of the present invention provides an extract of T. ferdinandiana including extract of T. ferdinandiana leaf provided as an antimicrobial agent.

The extract or composition may include one or more anti-oxidant. The one or more antioxidant may include an ellagic acid. The ellagic may include ellagic acid dehydrate and/or trimethyl ellagic acid.

A further aspect of the present invention provides a spray solution, a concentrate for subsequent dilution prior to use, a ready to use solution, a solid product for dispersal in a solution, or a solid product for inclusion in packaging or a transport container, having a composition containing an extract derived from Terminalia ferdinandiana (T. ferdinandiana) leaf as an antimicrobial agent.

Another aspect of the present invention may include an antimicrobial composition containing an extract derived from Terminalia ferdinandiana (T. ferdinandiana) leaf.

The composition may be applied by dipping or drenching the food product in a solution containing the composition.

The composition or extract may include lactic acid. The lactic acid may be provided as a free radical scavenging agent and/or as an anti-oxidant.

Preferably the extract is for use in a bacteria inhibition composition.

The extract or composition of T. ferdinandiana may include at least one tannin and/or at least one flavone.

The at least one tannin may include one of or a combination of two or more of, chebulic acid, corilagen, chebulinic acid and chebulagic acid.

Alternatively, or in addition, the extract or composition may include at least one flavone or flavinoid, such as luteolin.

It will be appreciated that one or more forms of the present invention may be, or may be included or incorporated into, one or more of the following products: a spray solution (such as in an aerosol or pump spray), a concentrate for subsequent dilution prior to use, a ready to use solution, a solid product for dispersal in a solution, a solid product for inclusion in packaging or a transport container with the processed or pre-processing raw or cooked or partly cooked animal or plant product.

### BRIEF DESCRIPTION OF THE FIGURES

One or more embodiments or examples of the present invention will hereinafter be described with reference to the accompanying Figures, in which:

FIG. 1 is a chart showing growth inhibitory activity of the Terminalia ferdinandiana extracts against the S. putrefaciens environmental isolates measured as zones of inhibition (mm) in relation to at least one embodiment of the present invention.

FIG. 2 is a chart showing growth inhibitory activity of the Terminalia ferdinandiana extracts against the S. baltica environmental isolates measured as zones of inhibition (mm) in relation to at least one embodiment of the present invention.

FIG. 3 is a chart showing growth inhibitory activity of the Terminalia ferdinandiana extracts against the S. frigidimarina environmental isolates measured as zones of inhibition (mm) in relation to at least one embodiment of the present invention.

FIG. 4 is a chart showing growth inhibitory activity of the Terminalia ferdinandiana extracts against the S. loihica environmental isolates measured as zones of inhibition (mm) in relation to at least one embodiment of the present invention.

M=methanolic extract; W=aqueous extract; E=ethyl acetate extract; C=chloroform extract; H=hexane extract; Amp=ampicillin (10 μg). Results are expressed as mean zones of inhibition ±SEM.

FIG. 5 is a chart showing inhibition of bacterial growth on southern black sea bream fish fillets by methanolic T. ferdinandiana fruit and leaf extracts.

In relation to the results shown in FIG. 5, total viable bacterial growth was calculated across a 15 day period as log10 CFU and is reported as a % of the untreated bacterial growth for each treatment. Bacterial growth for all treatment groups were measured at 5 day intervals following inoculation. Results are expressed as mean zones of inhibition ±SEM of 3 portions in triplicate at each time interval. * indicates results that are significantly different to the untreated control (p<0.01).

FIG. 6 is a chart consisting of FIGS. 6a and 6b. FIG. 6 shows the lethality of the Terminalia ferdinandiana extracts (2000 μg/mL) and the potassium dichromate (1000 μg/mL) and seawater controls towards Artemia franciscana nauplii after 24 hours exposure. M=methanolic extract; W=aqueous extract; E=ethyl acetate extract; C=chloroform extract; H=hexane extract; NC=negative (seawater) control; PC=potassium dichromate control (1000 μg/mL). Results are expressed as mean % mortality ±SEM.

FIG. 7 shows charts of total compound chromatograms (TCC) of 2 μL injections the methanolic T. ferdinandiana leaf extract in (a) positive and (b) negative ion RP-HPLC mode relating to at least one embodiment of the present invention.

### DESCRIPTION OF PREFERRED EMBODIMENT(S)

T. ferdinandiana leaves were extensively dehydrated in a dehydrator. The resulting desiccated leaf material was stored at −30° C.

T. ferdinandiana fruit pulp was also extensively dehydrated in a dehydrator. The resulting desiccated fruit pulp was stored at −30° C.

The dried leaf and fruit pulp plant materials were ground into a coarse powder prior to use. A mass of 1 g of ground fruit and leaf powders was extensively extracted in 50 mL of either methanol, deionised water, ethyl acetate, chloroform or hexane or for 24 h at 4° C. with gentle shaking. The extracts were filtered through filter paper and air dried at room temperature. The aqueous extract was lyophilised by rotary evaporation in a concentrator. The resultant pellets were dissolved in 10 mL deionised water (containing 0.5% dimethyl sulfoxide DMSO) and subsequently passed through a 0.22 μm filter and stored at 4° C. until used.

Antioxidant capacity: The antioxidant capacity of each sample was assessed using a modified 2,2-diphenyl-1-picrylhydrazyl (DPPH) free radical scavenging method. Ascorbic acid (0-25 μg per well) was used as a reference and the absorbances were measured and recorded at 515 nm. All tests were completed alongside controls on each plate and all were performed in triplicate.

The antioxidant capacity based on DPPH free radical scavenging ability was determined for each extract and expressed as μg ascorbic acid equivalents per gram of original plant material extracted.

Antibacterial screening: Environmental Shewanella strains: Shewanella putrefaciens strain 200, Shewanella baltica strain OS155, Shewanella frigidimarina strain NCIMB 400 and Shewanella loihica strain PV-4 were used. Antibacterial screening was achieved using a modified peptone/yeast extract (PYE) agar containing: 1 g/L peptone, 1.5 g/L yeast extract, 7.5 g/L NaCl, 1 g/L ammonium persulfate, 2.4 g/L HEPES buffer (pH 7.5) and 16 g/L bacteriological agar.

The S. putrefaciens and S. loihica cultures were incubated at 30° C. for 24 h. The S. baltica and S. frigidimarina cultures were incubated at 15° C. for 72 h. All stock cultures were subcultured and maintained in PYE media at 4° C.

Evaluation of antibacterial activity: Antibacterial activity screening of the T. ferdinandiana fruit and leaf extracts was assessed using a modified disc diffusion assay. Briefly, 100 μL of each individual Shewanella spp. was grown separately in 20 mL of fresh nutrient broth until an approximate count of 108 cells/mL was achieved. A volume of 100 μL of each bacterial suspension was spread onto nutrient agar plates and the extracts were tested for antibacterial activity using 5 mm sterilised filter paper discs. Discs were infused with 10 μL of the T. ferdinandiana fruit and leaf extracts, allowed to dry and placed onto the inoculated plates. The plates were left to stand at 4° C. for 2 h before incubation.

Plates inoculated with S. putrefaciens or S. loihica cultures were incubated at 30° C. for 24 h. S. baltica or S. frigidimarina cultures were incubated at 15° C. for 72 h. The diameters of the inhibition zones were measured to the closest whole millimetre. Each assay was completed in at least triplicate. Mean values (±SEM) are reported in this study. Ampicillin discs (10 μg) were obtained and used as positive controls to compare antibacterial activity. Filter discs infused with 10 μL of distilled water were used as a negative control.

Minimum inhibitory concentration (MIC) determination: The minimum inhibitory concentration for each extract was determined using two methods. A liquid dilution MIC assay was employed as it is generally considered the most sensitive bacterial growth inhibitory assay.

Furthermore, as microplate liquid dilution MIC assays are an often used method of quantifying bacterial growth inhibition efficacy, use of this method allows for comparisons. A solid phase agar disc diffusion assay was also used in this study as this bioassay was deemed to provide a closer representation of the environment and conditions relevant to a solid fish preservative system.

Microplate liquid dilution MIC assay: The MICs of the extracts were evaluated by standard methods. Briefly, overnight bacterial cultures were added dropwise to fresh nutrient broth and the turbidity was visually adjusted to produce a McFarlands number 1 standard culture. This was subsequently diluted 1 in 50 with nutrient broth, resulting in the MIC assay inoculum culture. A volume of 100 μL sterile broth was added to all wells of a 96 well plate. Test extracts or control antibiotics (100 μL) were then added to the top row of each plate and 1 in 2 serial dilutions were prepared in each column of wells by transferring 100 μL from the top well to the next well in each column, etc.

A growth control (without extract) and a sterile control (without inoculum) were included on each plate. A volume of 100 μL of bacterial culture inoculum was added to all wells except the sterile control wells.

Plates inoculated with S. putrefaciens or S. loihica cultures were incubated at 30° C. for 24 h. Plates inoculated with S. baltica or S. frigidimarina cultures were incubated at 15° C. for 72 h. p-Iodonitrotetrazolium violet (INT) was obtained and dissolved in sterile deionised water to prepare a 0.2 mg/mL INT solution.

A 40 μL volume of this solution was added into all wells and the plates were incubated for a further 6 hours at 30° C. Following incubation, the MIC was visually determined as the lowest dose at which colour development was inhibited.

Disc diffusion MIC assay: The minimum inhibitory concentrations (MIC) of the extracts was also evaluated by disc diffusion assay. Briefly, the T. ferdinandiana fruit and leaf extracts were diluted in deionised water and tested across a range of concentrations. Discs were impregnated with 10 μL of the extract dilutions, allowed to dry and placed onto inoculated plates. The assay was achieved as outlined above and graphs of the zone of inhibition versus concentration were plotted. Determination of MIC values were achieved using linear regression.

Inhibition of bacterial growth on fish fillets by T. ferdinandiana extracts: Innoculation of southern black sea bream fillets: Freshly filleted southern black sea bream (Acanthopagrus butcheri Munro) was obtained. All of the fish fillets were stored fresh at 4° C. and were purchased at 10 am on the same day as harvesting. The edges were asceptically excised and discarded from each fillet. The remainder of the fillets were excised asceptically to produce fish fillet cubes with 1 cm square ends, each with 2 surfaces (each 1 cm3) which had been exposed to atmospheric bacterial contamination. The cubes were separated into 5 groups (n=45):

(1) immersion in 1 M NaCl solution (control), (2) immersion 2000 μg/mL methanolic T. ferdinandiana fruit extract in 1 M NaCl solution, (3) immersion 500 μg/mL methanolic T. ferdinandiana fruit extract in 1 M NaCl solution, (4) immersion 2000 μg/mL methanolic T. ferdinandiana leaf extract in 1 M NaCl solution, (5) immersion 500 μg/mL methanolic T. ferdinandiana leaf extract in 1 M NaCl solution.

All test groups were immersed in the respective treatments for 6 hours. The cubes were subsequently removed from the treatments and allowed to drain asceptically. Three portions of each group were immediately sampled (day 0). The remainder of the portions for each group were stored separately in closed sterile containers at 4° C. Three further portions were sampled from each group at 5, 10 and 15 days following inoculation for growth time course studies.

Determination of colony forming units (cfu) in southern black sea bream fillets: To examine the effect of T. ferdinandiana fruit and leaf methanolic extracts on bacterial growth time in the southern black sea bream fillet, individual portions were sampled in triplicate for each treatment at 0, 5, 10 and 15 days following treatment. Each portion was individually homogenised using an overhead immersion blender and filtered through Whatman No. 54 filter paper at 4° C. Following homogenisation, 1 in 10 serial dilutions were prepared from each homegenate in a 1 M NaCl solution across the range 10-3-10-7. For enumeration of viable bacteria number, a volume of 100 μL of each suspension was spread onto individual nutrient agar plates. The plates were incubated at 30° C. for 24 h and the bacterial load (colonies/mL of sample) was enumerated by direct colony counts and expressed as a % ±SEM of the untreated control colony counts (group 1) for each time point.

Artemia franciscana nauplii toxicity screening: Toxicity was assessed using a modified Artemia franciscana nauplii lethality assay. Briefly, 400 μL of seawater containing ˜53 (mean 52.7, n=125, SD 11.8) A. franciscana nauplii were added to wells of a 48 well plate and immediately used in the bioassay. A volume of 400 μL of the reference toxin or the diluted plant extracts were transferred to the wells and incubated at 25±1° C. under artificial light (1000 Lux). For each plate, a 400 μL seawater negative control was run in triplicate. The wells were assessed at regular intervals and the number of dead counted. The nauplii were deemed dead if no movement of the appendages was observed within 10 seconds. After 24 h, all nauplii were sacrificed and counted to determine the total % mortality per well. The LC50 with 95% confidence limits for each treatment was calculated using probit analysis.

HPLC-MS/MS analysis: Chromatographic separations were performed using 2 μL injections of sample onto an Agilent 1290 HPLC system fitted with a Zorbax Eclipse plus C18 column (2.1×100 mm, 1.8 μm particle size). The mobile phases consisted of (A) ultrapure water and (B) 95:5 acetonitrile/water at a flow rate of 0.7 mL/min. Both mobile phases were modified with 0.1% (v/v) glacial acetic acid for mass spectrometry analysis in positive mode and with 5 mM ammonium acetate for analysis in negative mode. The chromatographic conditions utilised for the study consisted of the first 5 min run isocratically at 5% B, a gradient of (B) from 5% to 100% was applied from 5 min to 30 min, followed by 3 min isocratically at 100%.

Mass spectrometry analysis was performed on a quadrapole time-of-flight spectrometer fitted with an electrospray ionisation source in both positive and negative mode. Data were analysed using the qualitative analysis software package.

Blanks using each of the solvent extraction systems were analysed using the Find by Molecular Feature algorithm in the software package to generate a compound list of molecules with abundances greater than 10,000 counts. This was then used as an exclusion list to eliminate background contaminant compounds from the analysis of the extracts. Each extract was then analysed using the same parameters using the Find by Molecular Feature function to generate a putative list of compounds in the extracts. Compound lists were then screened against three accurate mass databases; a database of known plant compounds of therapeutic importance generated specifically for this study (800 compounds); the Metlin metabolomics database (24,768 compounds); and the Forensic Toxicology Database by Agilent Technologies (7,509 compounds). Empirical formula for unidentified compounds was determined using the Find Formula function in the software package.

Statistical analysis: Data is expressed as the mean ±SEM of at least three independent experiments. One way ANOVA was used to calculate statistical significance between control and treated groups with a P value <0.01 considered to be statistically significant.

RESULTS: Liquid extraction yields and qualitative phytochemical screening: T. ferdinandiana fruit and leaf extractions (1 g) with various solvents yielded dried plant extracts ranging from 18 mg to 483 mg (fruit extracts) and 58 mg to 471 mg (leaf extracts) (Table 1).

Aqueous and methanolic extracts provided significantly greater yields of extracted material relative to the chloroform, ethyl acetate and hexane counterparts, which gave low to moderate yields. The dried extracts were resuspended in 10 mL of deionised water (containing 1% DMSO), resulting in the concentrations presented in Table 1.

TABLE 1
The mass of dried extracted material, the concentration after resuspension in deionised water, qualitative phytochemical screenings and antioxidant capacities of the T. ferdinandiana fruit and leaf extracts.

| | | | Anti- | | | | | | | | | | | | | |
|---|---|---|---|---|---|---|---|---|---|---|---|---|---|---|---|---|
| | | | oxidant | | | | | | | | | | | | | |
| | Mass | Concen- | Capacity | | | | | | | | | | | | | |
| | of | tration of | (mg | | Water | Water | | | | | | | | | | Com- |
| | Dried | Resus- | Ascorbic | | Sol- | Insol- | | | | | Alka- | Alka- | | | Free | bined |
| | Ex- | pended | Acid | Total | uble | uble | Cardiac | | | | loids | loids | | | Anthra- | Anthra- |
| Ex- | tract | Extract | Equiv- | Phe- | Phe- | Phe- | Glyco- | Sap- | Triter- | Phyto- | (Mayer | (Wagner | Flavo- | Tan- | qui- | qui- |
| tract | (mg) | (mg/mL) | alency) | nolics | nolics | nolics | sides | onins | penes | steroids | Test) | Test) | noids | nins | nones | nones |
| FM | 359 | 35.9 | 660 | +++ | +++ | +++ | − | ++ | + | − | + | + | +++ | ++ | − | − |
| FW | 483 | 48.3 | 264 | +++ | +++ | +++ | − | + | − | − | − | − | +++ | ++ | − | − |
| FE | 30 | 3 | 39 | ++ | ++ | + | − | + | ++ | − | − | − | ++ | − | − | − |
| FC | 62 | 6.2 | 7 | + | − | − | − | − | − | − | − | − | − | − | − | − |
| FH | 18 | 1.8 | 1 | − | − | − | − | − | − | − | − | − | − | − | − | − |
| LM | 331 | 33.1 | 150 | +++ | +++ | +++ | +++ | ++ | + | − | + | + | ++ | +++ | + | + |
| LW | 471 | 47.1 | 340 | +++ | +++ | +++ | ++ | +++ | ++ | − | − | − | ++ | +++ | + | + |
| LE | 59 | 5.9 | 22 | +++ | +++ | +++ | − | − | − | − | − | − | ++ | ++ | − | − |
| LC | 59 | 5.9 | 5 | + | − | − | − | − | − | − | − | − | − | − | − | − |
| LH | 58 | 5.8 | 0.4 | + | − | − | − | − | − | − | − | − | ++ | + | − | − |

In Table 1, +++ indicates a large response, ++ indicates a moderate response, + indicates a minor response, − indicates no response in the assay.

FM=Methanolic T. ferdinandiana fruit extract; FW=aqueous T. ferdinandiana fruit extract; FE=ethyl acetate T. ferdinandiana fruit extract; FC=chloroform T. ferdinandiana fruit extract; FH hexane T. ferdinandiana fruit extract.

LM=Methanolic T. ferdinandiana leaf extract; LW=aqueous T. ferdinandiana leaf extract; LE=ethyl acetate T. ferdinandiana leaf extract; LC=chloroform T. ferdinandiana leaf extract; LH hexane T. ferdinandiana leaf extract.

Antioxidant capacity was determined by DPPH reduction and expressed as milligrams (mg) ascorbic acid equivalence per gram (g) plant material (fruit or leaf) extracted.

Antixodidant content: Antioxidant capacity for the plant extracts (Table 1) ranged from 0.4 mg (hexane leaf extract) to a high of 660 mg ascorbic acid equivalence per gram of dried plant material extracted (methanolic fruit extract). The aqueous and methanolic extracts generally had higher antioxidant capacities than the corresponding chloroform, hexane and ethyl acetate extracts.

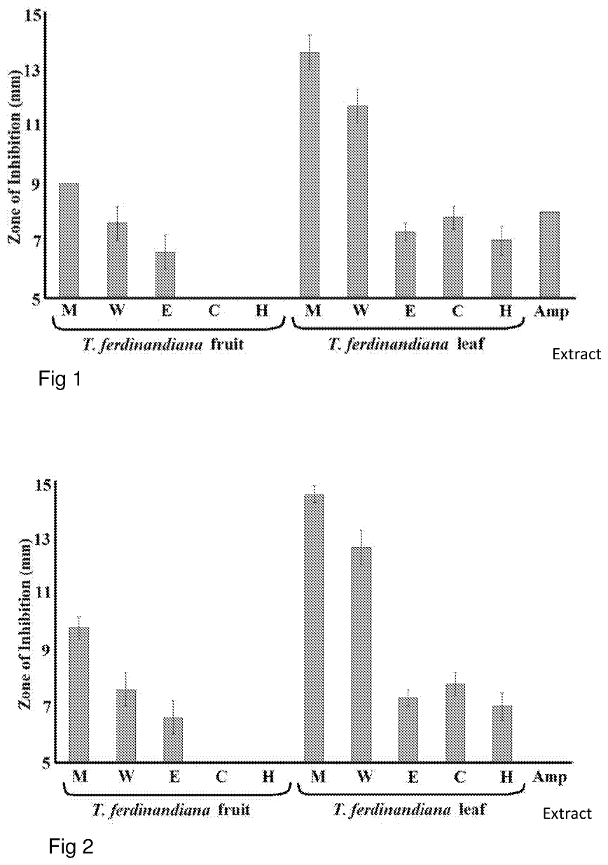

Growth inhibition of Shewanella spp.: To determine the ability of the T. ferdinandiana fruit and leaf extracts to inhibit Shewanella spp. growth, 10 μL of each extract was screened using a disc diffusion assay. S. putrefaciens growth was inhibited by the methanolic, aqueous and ethyl acetate T. ferdinandiana fruit extracts and all of the leaf extracts (FIG. 1).

Only the chloroform and hexane fruit extracts were devoid of S. putrefaciens growth inhibitory activity.

The methanolic and aqueous leaf extracts were particularly potent inhibitors of S. putrefaciens, each with zones of inhibition substantially >11 mm. This compared favourably with the ampicillin control (10 μg) which had zones of inhibition of 8.3±0.6 mm. As S. putrefaciens is a main causative agent for microbial fish spoilage (at both mesophilic and psychrophilic conditions), these are particularly noteworthy results.

Whilst the methanolic, aqueous and ethyl acetate fruit extracts, as well as the chloroform and hexane leaf extracts, also inhibited S. putrefaciens growth, they were generally less potent than the corresponding methanolic extracts.

The lower efficacy of the low polarity extracts compared to the higher polarity extracts indicates that the most potent and/or most abundant growth inhibitory compounds are polar.

As seafood is generally stored using low temperature conditions, other psychrotrophic and psychrophilic Shewanella spp. have increased importance at lower temperatures.

Control of S. baltica growth, and to a lesser extent S. frigidimarina growth, become more important when seafood (e.g. fish) are stored at lower temperatures for extended periods and the contribution of S. putrefaciens decreases.

The growth of S. baltica was also susceptible to the T. ferdinandiana fruit and leaf extracts (FIG. 2).

Consistent with the trend noted for S. putrefaciens growth inhibition, S. baltica also appeared more susceptible to the methanolic extracts than to the aqueous extract and the less polar extracts.

Furthermore, the leaf extracts were substantially more potent growth inhibitors than were the corresponding T. ferdinandiana fruit extracts.

As reported above for S. putrefaciens growth inhibition, the methanolic and aqueous leaf extracts were particularly potent inhibitors of S. baltica growth, with inhibition zones of 14.6±0.3 mm and 12.7±0.6 mm respectively.

The inhibition of S. baltica growth was particularly noteworthy as the growth of this bacterium was unaffected by ampicillin, indicating that this is an antibiotic resistant strain.

The methanolic fruit extract was also a good inhibitor of S. baltica growth (inhibition zone=9.8±0.4 mm). With the exception of the fruit chloroform and hexane extracts which were devoid of inhibitory activity, all other extracts were moderate inhibitors of S. baltica growth (as determined by zones of inhibition).

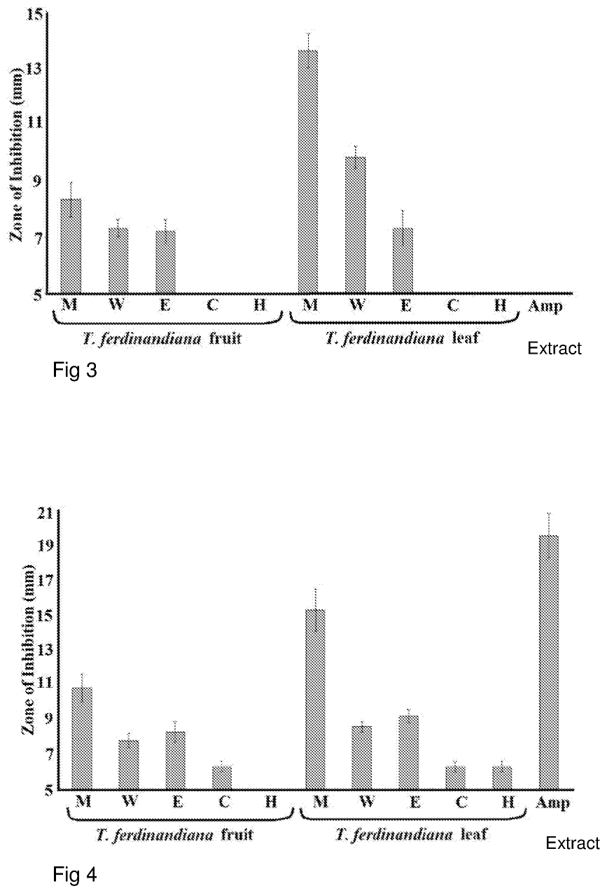

Growth of S. frigidimarina was also inhibited by several of the T. ferdinandiana fruit and leaf extracts (FIG. 3).

As evident for the inhibition of the growth of S. baltica and S. frigidimarina, the methanolic extracts were generally more potent S. frigidimarina growth inhibitors than were the other corresponding solvent extracts.

The methanolic leaf extract was particularly potent, with an inhibition zone of 18.6±0.6 mm.

Notably, as for the other psychrotrophic bacterial species (S. baltica ), S. frigidimarina growth was also resistant to ampicillin exposure.

The aqueous leaf extract was also a potent growth inhibitor (inhibition zone =9.8±0.4 mm).

The fruit methanolic, aqueous and ethyl acetate extracts, as well as the leaf ethyl acetate extracts also inhibited S. frigidimarina growth, albeit with smaller zones of inhibition indicative of moderate inhibitory activity.

All chloroform and hexane extracts were completely devoid of S. frigidimarina growth inhibitory activity.

S. loihica and S. putrefaciens share similar genotypic and phenotypic characteristics and have similar optimal growth conditions.

Thus, the ability of the T. ferdinandiana fruit and leaf to inhibit S. loihica was also tested (FIG. 4). In contrast with the other Shewanella spp., S. loihica was particularly susceptible to the ampicillin control (zone of inhibition of 19.6±1.3 mm). Whilst substantially smaller zones of inhibition were recorded against most of the T. ferdinandiana fruit and leaf extracts, several displayed potent S. loihica growth inhibition. Indeed, exposure of S. loihica to the methanolic fruit and leaf extracts produced >10 mm zones of inhibition. As evident for the growth inhibition of the other Shewanella spp., the methanolic T. ferdinandiana fruit extract was the most potent growth inhibitor (as assessed by the inhibition diameter), with an inhibition zone of 15.3±1.2 mm measured.

In contrast, an inhibition zone of 10.8±0.8 mm was measured for the methanolic fruit extract. Whilst the fruit aqueous, ethyl acetate and chloroform extracts, as well as the leaf hexane extracts also inhibited S. loihica growth, substantially smaller zones of inhibition were measured.

Quantification of minimum inhibitory concentration (MIC): The relative level of antimicrobial activity was further evaluated by determining the MIC values (Table 2) for each extract against the Shewanella spp. which were shown to be susceptible in the disc diffusion screening assays.

A similar trend was noted as seen for the screening assays i.e. the T. ferdinandiana leaf extracts were substantially better inhibitors of all Shewanella spp. growth than were the corresponding fruit extracts.

Furthermore, the methanolic extracts were generally the most potent growth inhibitors. The methanolic leaf extract was a particularly potent S. putrefaciens growth inhibitor, with disc diffusion (DD) and liquid dilution (LD) MIC values of 93 and 73 μg/mL respectively. This is substantially more potent than the methanolic fruit extract (DD MIC 1160 μg/mL; LD MIC 980 μg/mL). The T. ferdinandiana methanolic leaf extract was also a potent inhibitor of S. baltica (DD MIC 104 μg/mL; LD MIC 85 μg/mL), S. frigidimarina (DD MIC 466 μg/mL; LD MIC 391 μg/mL) and S. loihica growth (DD MIC 95 μg/mL; LD MIC 55 μg/mL). The aqueous and ethyl acetate T. ferdinandiana leaf extracts also had low MIC values against all Shewanella spp. growth, albeit with MIC values often an order of magnitude higher than for the corresponding leaf extracts. In further contrast to the leaf extracts where the methanolic extract had the greatest potency, the ethyl acetate extract was generally the most potent of the fruit extracts.

Inhibition of of bacterial growth on southern black sea bream fillets: Whilst psychrotrophic and psychrophilic Shewanella spp. are generally acknowledged as a major cause of cold stored fish spoilage, other bacterial species would also contribute to spoilage.

Furthermore, whilst the MIC assay methods used in our study provide important information of the ability of the extracts to inhibit Shewanella spp. growth in vitro, they do not necessarily accurately portray bacterial spoilage in commercial cold stored fish. Therefore, the T. ferdinandiana fruit and leaf extracts were tested for the ability to inhibit bacterial growth in fish fillets under cold storage conditions.

As the methanolic extracts were generally the most effective growth inhibitors (Table 2), only these extracts were tested in the fish fillet spoilage assessment. T his study did not discriminate between bacterial species, instead measuring the total viable bacteria as colony forming units (cfu). Furthermore, as cold storage is the most common preservation method for fresh fish, the fish fillets used in this study were also stored at 4° C. throughout the assessment period. The results are expressed as a % cfu of the control fish fillets (no treatment, held at 4° C.) to determine the degree of improvement over cold storage alone.

All treatments with the methanolic fruit and leaf T. ferdinandiana extracts were effective at reducing the number of viable bacteria on the fillets immediately following treatment, indicating that the extracts were bactericidal at 0.5 mg/mL. Indeed, the cfu's for all treated groups were inhibited by approximately 95% compared to the control fillets.

With the exception of the 0.5 mg/mL methanolic fruit extract, all extracts remained approximately as effective following 10 days cold storage as at the start of the test, each still inhibiting bacterial growth by approximately 95% compared to the control fillets. Although the 0.5 mg/mL methanolic fruit extract was not as effective following 10 days growth, it still inhibited bacterial growth by approximately 35% compared to the control fillets.

Following 15 days cold storage, the fruit extract (both concentrations) and the 0.5 mg/mL leaf extract treatment were less effective than earlier in the trial, with bacterial growth increasing to 50-85% of the levels in the control fillets.

These values represent a significant reduction in bacterial growth and indicate that all of extracts significantly decrease spoilage for at least 15 days.

Notably, the 2 mg/mL methanolic leaf extract treatment was still very effective at inhibiting bacterial growth at 15 days. Indeed, there was still approximately 90% reduction in bacterial growth at day 15 of the trial for this treatment. Thus, treatment with 2 mg/mL methanolic T. ferdinandiana leaf extract substantially decreases bacterial spoilage at 15 days, indicating its potential for increasing the shelf life of cold stored fish.

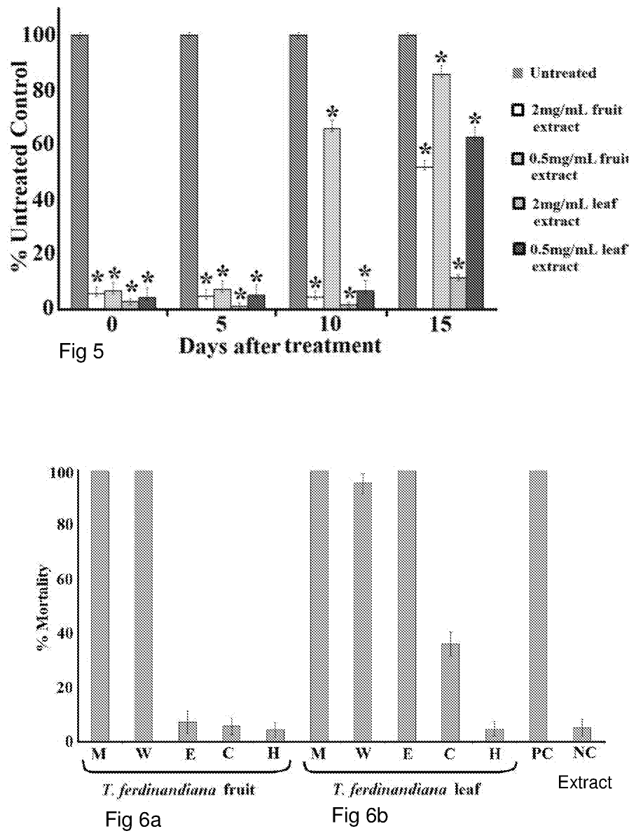

FIG. 5 shows a chart of inhibition of bacterial growth on southern black sea bream fish fillets by methanolic T. ferdinandiana fruit and leaf extracts.

In FIG. 5, the total viable bacterial growth was calculated across a 15 day period as logio CFU and is reported as a % of the untreated bacterial growth for each treatment.

Bacterial growth for all treatment groups were measured at 5 day intervals following inoculation. Results are expressed as mean zones of inhibition ±SEM of 3 portions in triplicate at each time interval. * indicates results that are significantly different to the untreated control (p<0.01).

As shown in FIG. 6, quantification of toxicity was conducted. All extracts were initially screened in the Artemia nauplii assay at 2000 μg/mL. Additionally, potassium dichromate (PC) was also tested in the bioassay as a reference toxin.

The reference toxin was rapid in its onset of mortality, promoting nauplii death within the first 3 h of exposure, with 100% mortality evident within 5 hours (unpublished results). All of the methanolic and aqueous extracts also induced 100% mortality following 24 h exposure. Similarly, the ethyl acetate leaf extract also induced 100% mortality at 24 h exposure. All other extracts induced <50% mortality and were therefore deemed to be nontoxic.

To further quantify the effects of toxin concentration on the initiation of mortality, the extracts were serially diluted in artificial seawater to test across a range of concentrations in the Artemia nauplii bioassay. The 24 h LC50 values of the T. ferdinandiana fruit and leaf extracts towards A. franciscana are displayed in Table 2. No LC50 are reported for any chloroform or hexane extracts, nor for the fruit ethyl acetate extract as <50% mortality was seen in all tested concentrations. LC50 values substantially >1000 μg/mL were determined for all of the other extracts. As extract with LC50 values >1000 μg/mL towards Artemia nauplii have been defined as being nontoxic in this assay, all of the T. ferdinandiana fruit and leaf extracts were deemed to be nontoxic.

All of the methanolic and aqueous extracts also induced 100% mortality following 24 hours of exposure. Similarly, the ethyl acetate extract also induced 100% mortality at 24 hours exposure. All other extracts induced <50% mortality and were therefore deemed to be nontoxic.

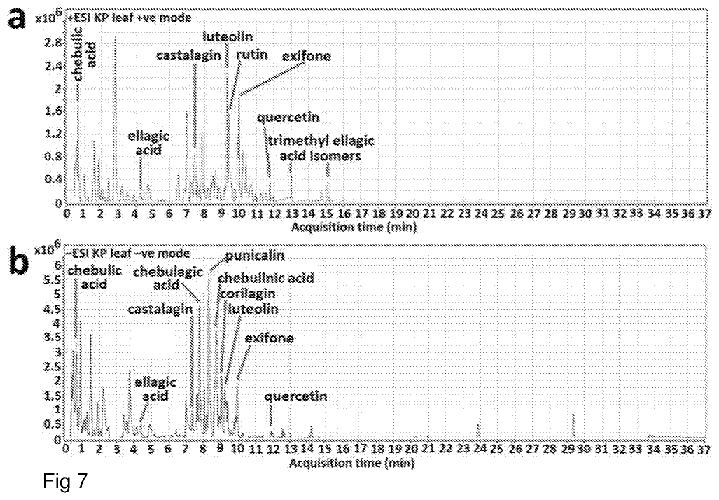

FIG. 7 shows charts of total compound chromatograms (TCC) of 2 μL injections the methanolic T. ferdinandiana leaf extract in (a) positive and (b) negative ion RP-HPLC mode. For ease of understanding, notable compounds putatively identified are indicated in the chromatograms.

Table 2 below shows results for disc diffusion and liquid dilution MICs against S. putrefaciens, S. baltica, S. frigidimarina and S. loihica growth (μg/mL) and Artemia nauplii bioassay LC50 values (μg/mL) of T. ferdinandiana fruit and leaf extracts.

TABLE 2

| | MIC (μg/mL) | | | | | | | | Atremia nauplii |
|---|---|---|---|---|---|---|---|---|---|
| | S. puirefaciens | | S. baltica | | S. frigidmarina | | S. loihica | | bioassay |
| | D.D. | L.D. | D.D. | L.D. | D.D. | L.D. | D.D. | L.D. | LC₅₀ (μg/mL) |
| F M | 1160 | 986 | 1077 | 991 | 1711 | 1471 | 1187 | 934 | 2028 |
| F W | 1869 | 1645 | 2202 | 2400 | 2774 | 2015 | 2636 | 1582 | 1980 |
| F E | 1000 | 860 | 4326 | >5000 | 1331 | 1025 | 932 | 692 | 1655 |
| F C | — | — | — | — | — | — | 4485 | >5000 | — |
| F H | — | — | — | — | — | — | — | | — |
| L M | 93 | 73 | 104 | 85 | 466 | 391 | 95 | 55 | 1283 |
| L W | 472 | 321 | 625 | 669 | 856 | 753 | 256 | 197 | 1375 |
| L E | 311 | 252 | 846 | 770 | 784 | 533 | 469 | 219 | 1068 |
| L C | 881 | 960 | 862 | 765 | — | — | 2562 | 1614 | — |
| L H | 841 | 807 | 1396 | 1160 | — | — | 2829 | 1924 | — |

D.D. = disc diffusion;
L.D. = liquid dilution;
Numbers indicate the mean D.D, MIC, L.D, MIC and LC₅₀ values of triplicate determinations.
— indicates no inhibition;
F = fruit;
L = leaf;
M = methanolic extract;
W = aqueous extract;
E = ethyl acetate extract;
C = chloroform extract;
H = hexane extract.

The methanolic leaf extract had the greatest antibacterial efficacy (as determined by MIC; Table 2).

Optimised HPLC-MS/MS parameters were developed and used to search for specific compound classes in the methanolic leaf extract and identify the individual components.

The resultant total compound chromatograms (TCC) for the positive ion and negative ion chromatograms are presented in FIG. 6 (FIGS. 6a and 6b) respectively.

The negative ion chromatogram had significantly higher background absorbance levels than the positive ion chromatogram, due to ionisation of the reference ions in this mode, possibly masking the signal for some peaks of interest.

The positive ion chromatogram (FIG. 6a) revealed the presence of numerous peaks, particularly in the early and middle stages of the chromatogram corresponding to the elution of polar compounds. Nearly all of the methanol extract compounds had eluted by 15 minutes (corresponding to approximately 40% acetonitrile). Several major peaks eluted in the first 1 minute with 5% acetonitrile. Similarly, the majority of the peaks detected in the negative ion methanolic T. ferdinandiana leaf extract TCC had eluted by 15 min. Several prominent peaks were also evident at elution times up to 30 min (100% acetonitrile), indicating that lower polarity compounds were also present in this extract.

The metabolomics fingerprinting approach used in this study targeted two specific phytochemical classes. High tannin contents are a defining feature of Terminalia spp. and high tannin contents have been reported in T. ferdinandiana (Cock, 2015).

Furthermore, a recent study characterised a number of tannin components in T. ferdinandiana leaf and correlated them with the inhibition of the growth of several pathogenic bacteria (Courtney et al, 2014). In total, 10 tannins were putatively identified in the methanolic T. ferdinandiana leaf extract by comparison to the Metlin metabolomics, forensic toxicology (Agilent) and phytochemicals (developed in this laboratory) databases.

Chebulic acid (2.2% total peak area in+ionisation mode), chebulagic acid (1.7% total peak area in−ionisation mode), corilagen (7.2% total peak area in−ionisation mode), ellagic acid (1.0% total peak area in−ionisation mode) and trimethyl ellagic acid esters (1.7% total peak area in+ionisation mode), exifone (1.9% total peak area in+ionisation mode) and punicalin (2.4% total peak area in−ionisation mode) were present in particularly high relative abundance (as assessed by their relative % peak area). All other tannins were present in lower relative abundances.

T. ferdinandiana fruit and leaf extracts were selected for screening for the ability to block the growth of spoilage bacteria as they have potential to positively influence the shelf life of perishable food product in several ways.

A major portion of fresh food spoilage, such as meat products e.g. seafood, fish, meat etc., is the result of oxidative spoilage.

The treatment of perishable food product with preparations containing high antioxidant contents (e.g. some plant extracts) decreases lipid oxidation and thus inhibits oxidative rancidity.

T. ferdinandiana fruit and leaf extracts, individually or combined, are potent inhibitors of Shewanella spp. growth and therefore have potential as natural fish/seafood preservatives.

The T. ferdinandiana leaf extracts were particularly effective against all psychrotrophic and mesophilic Shewanella spp. and thus have potential for both fresh and cold storage fish preservation.

All tested extracts of T. ferdinandiana leaf were found to be non-toxic in Artemia fransiscana (brine shrimp) bioassay.

Furthermore, all of the T. ferdinandiana extracts were nontoxic towards Artemia nauplii and are thus safe to use as natural fish preservatives.

1. A composition containing an extract derived from Terminalia ferdinandiana (T. ferdinandiana) leaf as an antimicrobial agent to preserve or prolong storage or shelf-life of perishable animal and/or plant based products.

2. The composition of claim 1, further including an extract of T. ferdinandiana fruit in addition to the extract of T. ferdinandiana leaf.

3. The composition of claim 1, wherein the T. ferdinandiana leaf extract includes one or more of a methanolic extract, aqueous extract, ethyl acetate extract, alcohol extract, chloroform extract or hexane extract.

4. The composition of claim 1, wherein the T. ferdinandiana leaf extract includes a proportion of at least one antioxidant.

5. The composition of claim 4, wherein the at least one antioxidant includes one or more of a lactic acid, an ellagic acid or a trimethyl ellagic acid.

6. The composition of claim 1, as an antimicrobial agent for use used with the perishable animal and/or plant based products being fresh, cooked or semi-cooked animal and/or plant products.

7. (canceled)

8. The composition of claim 1, wherein the animal products include marine animal based product(s).

9. The composition of claim 8, wherein the marine animal based product(s) include one or more of seafood, fish, octopus, cuttlefish, squid, jellyfish, chilled cooked or raw crustaceans, shellfish, prawn, shrimp, crab, lobster, fish, muscles, oysters.

10. A method of inhibiting growth of controlling bacteria on a food preparation surface, on a food preparation tool or utensil, on food packaging or on an internal or external surface of a food product, the method including applying bacteria includes applying a composition containing an extract of Terminalia ferdinandiana (T. ferdinandiana) leaf to the respective food preparation surface, the food preparation tool or utensil, the food packaging or to the internal or external surface of the food product.

11. The method of claim 10, wherein the applying the composition includes one or more of spraying the composition onto the respective surface or putting the respective surface into a solution containing the composition.

12. The method of claim 11, including applying the composition by dipping or drenching the food product in a solution containing the composition.

13. (canceled)

14. An extract of Terminalia ferdinandiana (T. ferdinandiana) including extract of T. ferdinandiana leaf provided as an antimicrobial agent.

15. The extract of claim 14 including at least one tannin and/or at least one flavone.

16. The extract of claim 14, including at least one tannin.

17. The extract of claim 16, including one of or a combination of two or more of, chebulic acid, corilagen, chebulinic acid and chebulagic acid.

18. The extract of claim 14, including at least one flavone or flavinoid.

19. The extract of claim 14, including one or more anti-oxidants.

20. The extract of claim 19, wherein the at least one antioxidant includes an ellagic acid

21. The extract of claim 20, wherein the ellagic acid includes ellagic acid dehydrate and/or trimethyl ellagic acid.

22. The composition of claim 1, provided in a spray solution, a concentrate for subsequent dilution prior to use, a ready to use solution, a solid product for dispersal in a solution, or a solid product for inclusion in packaging or a transport container.

23. (canceled)
